(19) United States
(12) Patent Application Publication
(10) Pub. No.: US 2023/0185368 A1
(43) Pub. Date: Jun. 15, 2023

(54) GAZED BASED CURSOR ADJUSTMENT

(71) Applicant: Lenovo (United States) Inc., Morrisville, NC (US)

(72) Inventors: Nathan Peterson, Oxford, NC (US); Russell Speight VanBlon, Raleigh, NC (US); Arnold Weksler, Raleigh, NC (US); John C. Mese, Cary, NC (US); Mark Delaney, Raleigh, NC (US)

(21) Appl. No.: 17/550,214

(22) Filed: Dec. 14, 2021

(51) Int. Cl. G06F 3/01; G06F 3/04812

(52) U.S. Cl. CPC G06F 3/013; G06F 3/04812

(57) ABSTRACT

One embodiment provides a method, including: detecting, using a camera sensor, a user gaze position on a display screen associated with an information handling device; identifying, using a processor, a first location of a cursor on the display screen; determining, using the processor, whether the first location of the cursor is greater than a predetermined distance away from the user gaze position; and adjusting, responsive to determining that the first location of the cursor is greater than the predetermined distance away from the user gaze position, the cursor from the first location to a second location on the display screen that is less than the predetermined distance away from the user gaze position. Other aspects are described and claimed.

### BACKGROUND

Individuals may interact with their information handling devices (“devices”), for example laptops and personal computers, tablets, hybrid devices, and the like, in a variety of different ways. For example, individuals may utilize an input device (e.g., a mouse, stylus, trackpad, etc.) to interact with contents presented on a display screen. Visual indications regarding an individuals' controlling position on the display are conventionally represented by a digital cursor that tracks the movements of the input device.

### BRIEF SUMMARY

In summary, one aspect provides a method, including: detecting, using a camera sensor, a user gaze position on a display screen associated with an information handling device; identifying, using a processor, a first location of a cursor on the display screen; determining, using the processor, whether the first location of the cursor is greater than a predetermined distance away from the user gaze position; and adjusting, responsive to determining that the first location of the cursor is greater than the predetermined distance away from the user gaze position, the cursor from the first location to a second location on the display screen that is less than the predetermined distance away from the user gaze position.

Another aspect provides an information handling device, including: a camera sensor; a display screen; a processor; a memory device that stores instructions executable by the processor to: detect a user gaze position on a display screen associated with an information handling device; identify a first location of a cursor on the display screen; determine whether the first location of the cursor is greater than a predetermined distance away from the user gaze position; and adjust, responsive to determining that the first location of the cursor is greater than the predetermined distance away from the user gaze position, the cursor from the first location to a second location on the display screen that is less than the predetermined distance away from the user gaze position.

A further aspect provides a product, including: a storage device that stores code, the code being executable by a processor and comprising: code that detects a user gaze position on a display screen associated with an information handling device; code that identifies a first location of a cursor on the display screen; code that determines whether the first location of the cursor is greater than a predetermined distance away from the user gaze position; and code that adjusts, responsive to determining that the first location of the cursor is greater than the predetermined distance away from the user gaze position, the cursor from the first location to a second location on the display screen that is less than the predetermined distance away from the user gaze position.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of adjusting a cursor location based upon a user's gaze position.

FIG. 4 illustrates region-based cursor adjustment according to an embodiment.

FIG. 5 illustrates region-based cursor adjustment according to an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Individuals frequently experience performance issues with integrated or peripheral input devices. For example, individuals that utilize a trackpad on a laptop to navigate around a display often complain that it is difficult to move the cursor large distances with ease (i.e., multiple swiping motions are often required before the cursor is moved to the desired location). Individuals utilizing a mouse may experience similar issues, especially if the surface the mouse is utilized on is suboptimal (e.g., a glass surface, a textured surface, an uneven surface, etc.).

In some instances, users may be able to remedy the foregoing issues by increasing the sensitivity of their input device so that smaller physical movements of the hand may effectuate a greater movement of the cursor across the display. Although effective in traversing distances quicker, such a solution makes it more difficult to settle the cursor on a desired object due to the increased sensitivity. Other solutions exist that may be able to track the location of a user's gaze on a display and then automatically position the cursor at that location. However, this solution may impede a user's perception of a desired object because the cursor may be more in the way than it needs to be.

Accordingly, an embodiment provides a method of dynamically adjusting a location of a cursor to be proximate to a user gaze position. In an embodiment, a position of a user's gaze on a display may be detected via a camera sensor. An embodiment may then identify a first location of a cursor on the display screen and determine whether the first location of the cursor is greater than a predetermined distance away from a user's gaze position. Responsive to determining that it is, an embodiment may thereafter adjust the cursor from the first location to a second location. The second location is less than the predetermined distance away from the user's gaze position and may be proximate to, but not overlapping, the user's gaze position.

The illustrated example embodiments will be best understood by reference to the figures. The following description is intended only by way of example, and simply illustrates certain example embodiments.

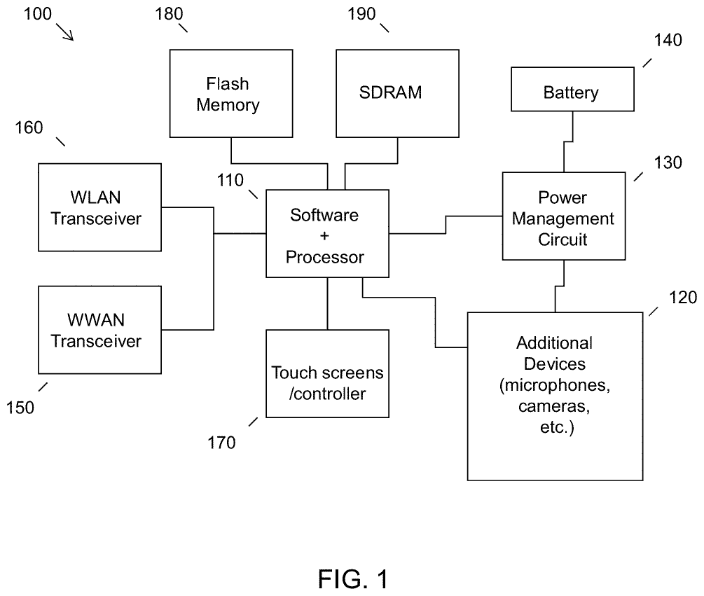

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, a thermal sensor, etc. System 100 often includes an augmented reality device 170 for data input and display/rendering. System 100 also typically includes various memory devices, for example flash memory 180 and SDRAM 190.

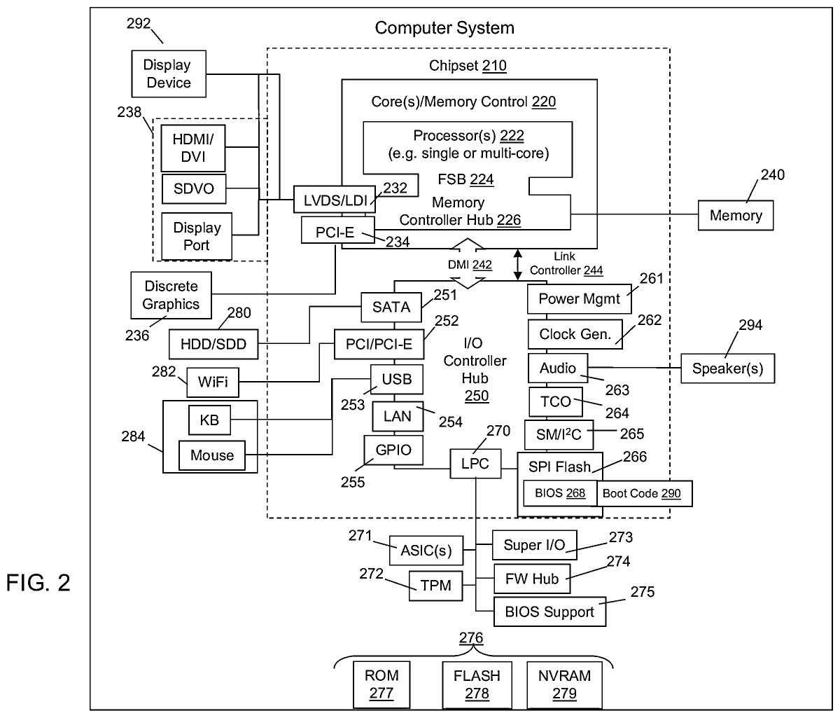

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices having an integrated input device or that are capable of connecting one or more peripheral input devices. For example, the circuitry outlined in FIG. 1 may be implemented in a laptop, whereas the circuitry outlined in FIG. 2 may be implemented in a personal computer embodiment.

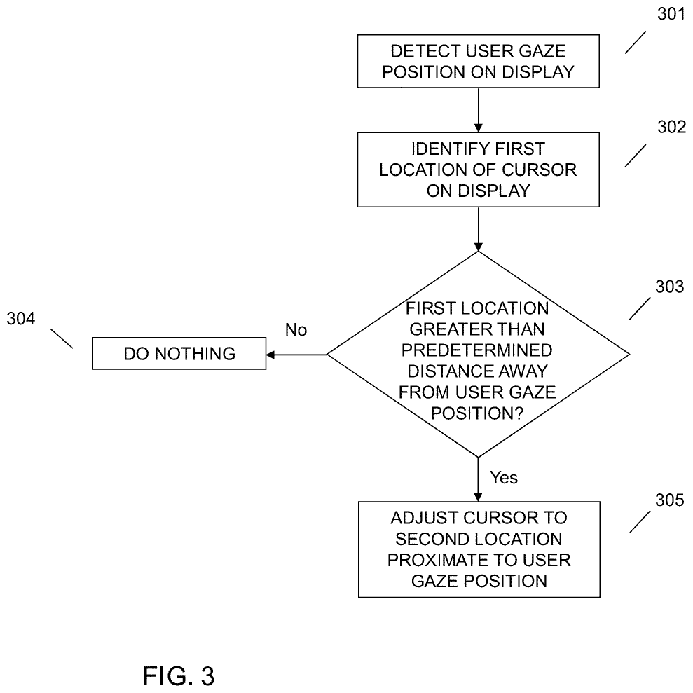

Referring now to FIG. 3, an embodiment may automatically adjust a position of a cursor on a screen to a location proximate to a user gaze position. At 301, an embodiment may detect a position of user gaze on a display screen of a device. In an embodiment, the display screen may be a screen that is integrated with the device or is operatively coupled to it (e.g., via a wired or wireless connection, etc.). In an embodiment, the detection may be facilitated via the use of one or more user-oriented camera sensors integrally or operatively coupled to the device. The camera sensor(s) may be configured to continuously capture image data or, alternatively, may be configured to capture image data in response to detection of a predetermined event (e.g., initiation of a particular application, detection of user presence in front of the device, etc.). In an embodiment, the identification of a user gaze position on the display may be accomplished by the utilization of one or more conventional gaze tracking techniques known in the art.

At 302, an embodiment may identify a first location of a cursor on the display screen. In the context of this application, the first location may be an original location of a cursor prior to its positional adjustment to another location, as further described below. Furthermore, it is important to note that the position of the cursor may be adjusted multiple times. Accordingly, the first location may simply correspond to the initial location of the cursor in a single cursor adjustment process, where multiple cursor adjustments may occur during a single use session. In an embodiment, the location of the cursor may be determined via consulting system logic regarding which portion of the display screen the cursor is being displayed over.

At 303, an embodiment may determine whether the first location of the cursor is greater than a predetermined distance away from the user gaze position. In an embodiment, the predetermined distance may be originally set by a manufacturer of the device and may later be adjusted by a user. In an embodiment, the predetermined distance may be based on one or more objective metrics, e.g., inches, pixels, etc. The identification of the distance between the cursor location and user gaze position may be accomplished automatically by the system (e.g., via leveraging system logic, etc.). In an embodiment, the determination may be further facilitated by comparing the identified distance between the first cursor location and the identified user gaze position with a predetermined distance metric stored in an accessible database (e.g., stored locally on the device, stored remotely in another device or server, etc.).

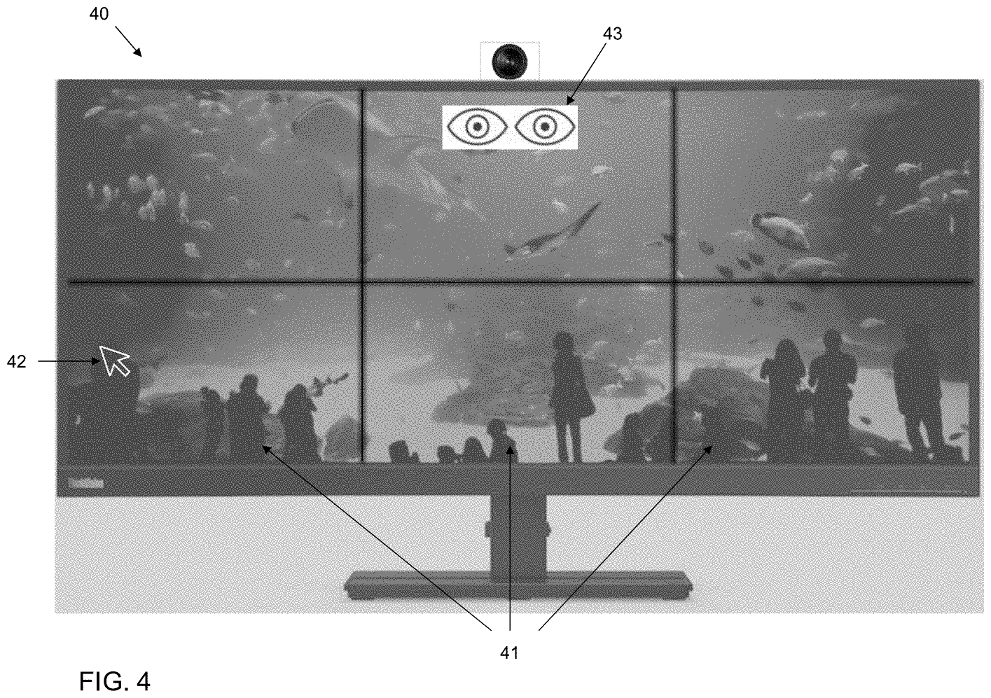

In another embodiment, the display screen may be segmented into a plurality of virtual regions. For instance, turning now to FIG. 4, a display screen 40 is segmented into six substantially equally-sized regions 41. These regions may be recognizable to a processor of a device but may not be visible to a user. It is important to note that the segmentation of the display into six regions is simply illustrative and the display can be segmented into virtually any number of equally or irregularly sized regions. In an embodiment, the predetermined distance may be based on the regions in which the cursor location and user gaze position are identified in. More particularly, the determination of whether the cursor location is greater than a predetermined distance away from the user gaze position may correspond to the determination of whether the cursor location is in the same region as the user gaze position. If an embodiment determines that both are in the same region, then an embodiment may conclude that the cursor location is less than the predetermined distance away from the user gaze position. In the sample illustration in FIG. 4, an embodiment may determine that the cursor location 42 is greater than a predetermined distance away from the user gaze position 43 because the cursor location 42 is not in the same region as the user gaze position 43.

Responsive to determining, at 303, that the first location of the cursor is not greater than a predetermined distance away from the user gaze position, an embodiment may, at 304, take no additional action. Conversely, responsive to determining, at 303, that the first location of the cursor is greater than the predetermined distance away from the user gaze position, an embodiment may, at 305, adjust the position of the cursor from the first location to a second location that is within the predetermined distance.

In an embodiment, the adjustment of the cursor may occur automatically in response to a positive determination. More particularly, the cursor may be adjusted from the first location to the second location without the receipt of any additional user input. In an embodiment, the second location of the cursor may be a location that is proximate to, but not directly overlapping the user gaze position. More particularly, the second location may be offset from the user gaze position by a predetermined distance (e.g., one inch, two inches, etc.) and/or by a predetermined direction (e.g., offset to the left of the user gaze position, offset to the right of the user gaze position, etc.) so as to not obscure a virtual object a user is looking at. The predetermined distance and direction of the offset may be originally set by a manufacturer and later adjusted by a user.

Additionally or alternatively to the foregoing, an embodiment may also take other data points into consideration when facilitating the offset. For instance, an embodiment may attempt to abide by the designated offset rules described above all while avoiding positioning the cursor over any other digital object proximate to the user gaze position (e.g., an icon, an image, a text block, etc.). In a non-limiting example, if a ruleset specifies that the second cursor location should be diagonally offset to the bottom left of the user gaze position by one inch and an embodiment identifies that a clickable icon is present in that offset position, an embodiment may dynamically set the second cursor location to the nearest empty space proximate to the clickable icon.

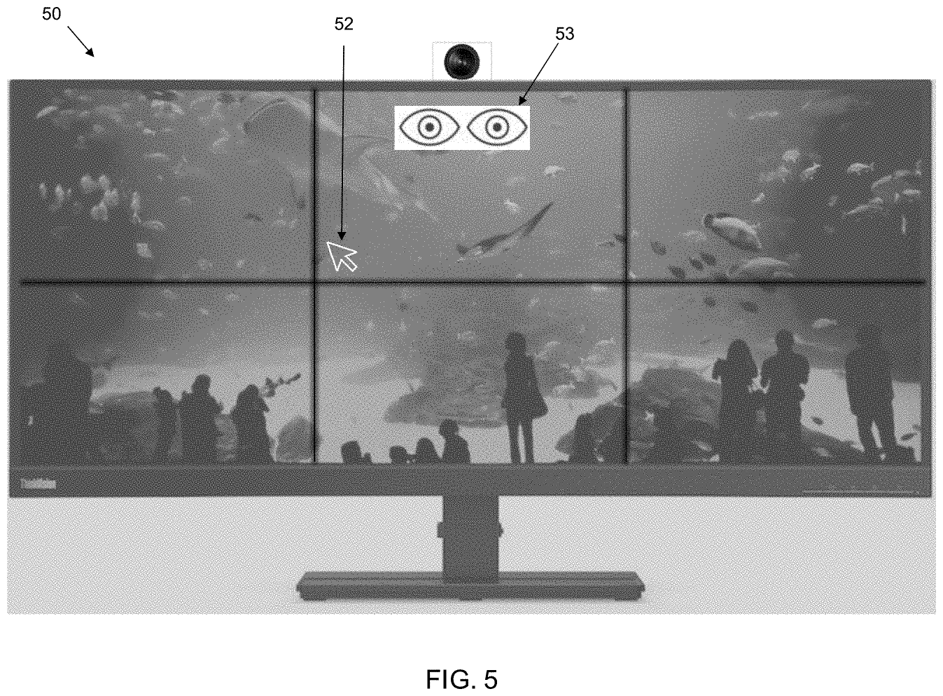

Additionally or alternatively to the foregoing concepts, in the situation where the display is segmented into a plurality of virtual regions, the second cursor location may be placed into a predetermined position within the region containing the user gaze position (e.g., a specific corner of the region, etc.). More particularly, each time a cursor location is dynamically adjusted to move between regions, the second cursor location may be configured to always be placed at the predetermined position within each region. For example, with reference to FIG. 5, a cursor has moved from a first cursor location 42 illustrated in FIG. 4 to a second cursor location 52 illustrated in FIG. 5 to be proximate to an identified user gaze position 53. In this system, a ruleset may specify that the second cursor location is always a bottom left corner of whatever region the cursor is adjusted into.

In an embodiment, a transparency setting of the cursor may be dynamically changed during the adjustment of the cursor position. More particularly, an embodiment may increase the transparency of the cursor during its relocation from the first position to the second position. A benefit of such a transparency change is to minimize distraction to the user as the cursor automatically adjusts its position. In an embodiment, the transparency setting may be increased by a predetermined amount (e.g., as designated by a manufacturer or user, etc.) or may be made to be fully transparent to the adjustment process.

In certain embodiments, the cursor position may not be adjusted until one or more additional data points are determined to be present. For instance, in one embodiment the cursor location may not be adjusted until it is also determined by the system that the user gaze position has remained consistent at a single position, or region, for a predetermined period of time (e.g., three seconds, five seconds, etc.). Such a “check” on the cursor adjustment process may ensure that the cursor position is not constantly being changed due to quick glances of a user around a display screen, which may be distracting and/or frustrating to a user.

In another embodiment, the cursor location may not be adjusted until it is also determined that an active application (i.e., one that is currently displayed on the screen and/or one that is being interacted with by a user) is designated as an enabled application for automatic cursor adjustment. An embodiment may facilitate this determination by consulting an accessible database that comprises a list of enabled applications and comparing the active application to the ones in the list to determine if a match exists. If a match exists, then an embodiment may implement the automatic cursor adjustment process as described above. However, if a match does not exist then an embodiment may not perform any type of automatic cursor adjustment. Such a “check” on the cursor adjustment process may ensure that the process is not implemented in applications where it does not benefit the user to have the cursor adjusted automatically (e.g., in gaming applications where the cursor location is important and a user is apt to frequently look around the screen, etc.)

The various embodiments described herein thus represent a technical improvement to conventional methods for adjusting the position of a cursor. Using the techniques described herein, an embodiment may detect a position of user gaze and may also identify a first location of a cursor on a display screen. An embodiment may then determine whether the first location of the cursor is greater than a predetermined distance away from the identified position of user gaze. Responsive to determining that it is, an embodiment may thereafter automatically adjust the cursor from the first location to a second location that is proximate to, but not overlapping, the user gaze position. Such a method may improve a user's computing experience by minimizing the instances in which a user needs to adjust a cursor large distances.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
detecting, using a camera sensor, a user gaze position on a display screen associated with an information handling device by segmenting the display screen into a plurality of virtual regions and locating the user gaze position in relation to one of the plurality of virtual regions;
identifying, using a processor, a first location of a cursor on the display screen, wherein the identifying comprises identifying a region of the plurality of virtual regions containing the cursor;
determining, using the processor, whether the first location of the cursor is greater than a predetermined distance away from the user gaze position; and
adjusting, responsive to determining that the first location of the cursor is greater than the predetermined distance away from the user gaze position and without receiving additional user input, the cursor from the first location to a second location on the display screen that is less than the predetermined distance away from the user gaze position, wherein the second location is proximate to the user gaze position.

2. (canceled)

3. The method of claim 1, wherein the second location is not overlapping the user gaze position.

4. The method of claim 1, wherein the adjusting comprises increasing, during the adjustment of the cursor from the first location to the second location, a transparency setting of the cursor.

5. The method of claim 1, wherein the determining comprises determining whether the user gaze position remains consistent for a predetermined period of time and wherein the adjusting comprises adjusting responsive to identifying that the user gaze position remains consistent for at least the predetermined period of time.

6. The method of claim 1, further comprising identifying an active application displayed on the display screen and wherein:
the determining comprises determining whether the active application is designated as an enabled application for automatic cursor adjustment; and
the adjusting comprises adjusting responsive to identifying that the active application displayed on the display screen is designated as an enabled application.

7. The method of claim 6, wherein the determining comprises accessing a database comprising a list of enabled applications for automatic cursor adjustment.

8. (canceled)

9. The method of claim 1, wherein the determining comprises determining whether the user gaze position and the first location of the cursor are both in an equivalent virtual region of the plurality of virtual regions and wherein the adjusting comprises adjusting responsive to identifying that the user gaze position and the first location of the cursor are not in the equivalent virtual region.

10. The method of claim 9, wherein the second location corresponds to a proximate location within another virtual region containing the user gaze position.

11. An information handling device, comprising:
a camera sensor;
a display screen;
a processor;
a memory device that stores instructions executable by the processor to:
detect a user gaze position on a display screen associated with an information handling device by segmenting the display screen into a plurality of virtual regions and locating the user gaze position in relation to one of the plurality of virtual regions;
identify a first location of a cursor on the display screen, wherein to identify comprises identifying a region of the plurality of virtual regions containing the cursor;
determine whether the first location of the cursor is greater than a predetermined distance away from the user gaze position; and
adjust, responsive to determining that the first location of the cursor is greater than the predetermined distance away from the user gaze position and without receiving additional user input, the cursor from the first location to a second location on the display screen that is less than the predetermined distance away from the user gaze position, wherein the second location is proximate to, but not overlapping, the user gaze position.

12. The information handling device of claim 11, wherein the second location is not overlapping the user gaze position

13. The information handling device of claim 11, wherein the instructions executable by the processor to adjust comprise instructions executable by the processor to increase, during the adjustment of the cursor from the first location to the second location, a transparency setting of the cursor.

14. The information handling device of claim 11, wherein the instructions executable by the processor to determine comprise instructions executable by the processor to determine whether the user gaze position remains consistent for at least the predetermined period of time.

15. The information handling device of claim 11, wherein the instructions are further executable by the processor to identify an active application displayed on the display screen and wherein:
the instructions executable by the processor to determine comprise instructions executable by the processor to determine whether the active application is designated as an enabled application for automatic cursor adjustment; and
the instructions executable by the processor to adjust comprise instructions executable by the processor to adjust responsive to identifying that the active application displayed on the display screen is designated as an enabled application.

16. The information handling device of claim 15, wherein the instructions executable by the processor to determine comprise instructions executable by the processor to access a database comprising a list of enabled applications for automatic cursor adjustment.

17. (canceled)

18. The information handling device of claim 11, wherein the instructions executable by the processor to determine comprise instructions executable by the processor to determine whether the user gaze position and the first location of the cursor are both in an equivalent virtual region of the plurality of virtual regions and wherein the instructions executable by the processor to adjust comprise instructions executable by the processor to adjust responsive to identifying that the user gaze position and the first location of the cursor are not in the equivalent virtual region.

19. The information handling device of claim 18, wherein the second location corresponds to a proximate location within another virtual region containing the user gaze position.

20. A product, comprising:
a storage device that stores code, the code being executable by a processor and comprising:
code that detects a user gaze position on a display screen associated with an information handling device by segmenting the display screen into a plurality of virtual regions and locating the user gaze position in relation to one of the plurality of virtual regions;
code that identifies a first location of a cursor on the display screen, wherein the code that identifies comprises identifying a region of the plurality of virtual regions containing the cursor;
code that determines whether the first location of the cursor is greater than a predetermined distance away from the user gaze position; and
code that adjusts, responsive to determining that the first location of the cursor is greater than the predetermined distance away from the user gaze position and without receiving additional user input, the cursor from the first location to a second location on the display screen that is less than the predetermined distance away from the user gaze position, wherein the second location is proximate to, but not overlapping, the user gaze position.
